(19) United States
(12) Patent Application Publication
(10) Pub. No.: US 2005/0267969 A1
(43) Pub. Date: Dec. 1, 2005

(54) Providing information on a resource in a communication system

(75) Inventors: Miikka Poikselka, Espoo (FI); Risto Kauppinen, Helsinki (FI); Jarmo Kuusinen, Jyvaskyla (FI); Jari Mutikainen, Helsinki (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 10/922,988

(22) Filed: Aug. 23, 2004

(30) Foreign Application Priority Data
Apr. 23, 2004 (FI) 20040577

(51) Int. Cl. G06F 15/173

(52) U.S. Cl. 709/225

(57) ABSTRACT

A method provides information on a resource in a communication system. The method includes receiving a request from a first entity in a second entity, the request being addressed to a second resource. The method also includes providing a response to the request comprising a group indication when the second resource defines a group comprising a number of individual resources. Furthermore, user terminals and entities in a communication system are provided configured to implement the method.

### FIELD OF THE INVENTION

The invention relates to communication systems, and more particularly to providing information on a resource in a communication system.

### BACKGROUND OF THE INVENTION

A communication system can be seen as a facility that enables communication sessions between two or more entities such as user terminal and/or other nodes associated with the communication system. Subscribers, such as the users or end-users, to a communication system may be offered and provided numerous services, such as two-way or multi-way calls, data communication or multimedia services or simply an access to a network, such as the Internet. The services may be offered by an operator of the communication system or by an external service provider.

Examples of communication systems may include fixed line communication systems, such as a public switched telephone network (PSTN), wireless communication systems, e.g. global system for mobile communications (GSM), general packet radio service (GPRS), universal mobile telecommunications system (UMTS), wireless local area network (WLAN) and so on, and/or other communication networks, such as an Internet Protocol (IP) network and/or other packet switched data networks. Various communication systems may simultaneously be concerned in a connection. An end-user may access a communication network by means of any appropriate user equipment (UE), for example a mobile terminal, such as a mobile station (MS), a cellular phone, a personal digital assistant (PDA) or the like, or other terminals, such as a personal computer (PC), or any other equipment operable according to a suitable network protocol, such as a wireless applications protocol (WAP) or a hypertext transfer protocol (HTTP). The user equipment may support, in addition to call and network access functions, other services, such as short message service (SMS), multimedia message service (MMS), electronic mail (email), Web service interface (WSI) messaging and voice mail.

The IP Multimedia Subsystem (IMS) is an example of a system providing multimedia services. The IMS uses the Session Initiation Protocol (SIP), which is an application layer control protocol defined by the Internet Engineering Task Force (IETF) for creating, modifying and terminating sessions with one or more participants. The SIP is defined in the document RFC 3261 “SIP: Session Initiation Protocol”.

Recently, a new direct one-to-one and one-to-many voice communication system named as Push to talk over Cellular (PoC) has been developed as a part of the service offering in the IMS. The PoC service is based on half-duplex Voice over IP (VoIP) technology in cellular networks, such as the GSM/GPRS network. The PoC uses an “always-on” connection, which allows a subscriber to have a direct access to the service after the subscription to the service without additional measures, such as dial-up. The PoC enables a subscriber to listen to group traffic. Call can be started to both individuals and groups with a simple action, such as a push of a key. The call connection is established automatically and the receiver does not need to answer the call. In the network, a controlling server takes care of session management, such as mixing the speech (i.e. the VoIP) for all members of a group.

Uniform Resource Identifiers (URIs) are used to identify different types of actors in a SIP-controlled network. Typically a URI points to a registered user identity of an individual user. A URI may identify also services, such as voicemail server or conference factory URI, conferencing instances, such as chat rooms or voice-over-IP (VoIP) conferencing instances, or other types of resources. In addition, a URI may point to a resource list, which may be a list of individual URIs, or in other words, a group of URIs. Resource lists may be used in many applications, such as for one-to-many messaging, and so on. For example, a server in a network may maintain resource lists of e.g. one operator. A request addressed to such a resource list may be routed to the server, which may forward the request to individual contacts behind the resource list.

Typically, the format of a URI does not reveal the nature of the URI. However, information on the nature of the URI, such as whether the URI comprises an individual user identity or a group of user identities, might be useful in many applications. For example, if the user has received an URI in a message, web page, or the like, it might be useful to know, if the URI points to the resource list or to an individual user. For example, a service usage may be more expensive for a group of users instead of a single user. In addition, invoking a multiparty service instead of one-to-one service might cause a security or confidentiality issues, if the user is not aware of being a part of the multiparty service. Furthermore, it might be useful to be able interrogate the actual resources behind the resource list.

A human user may in some cases be able to recognize a resource list URI, for example, from the context or from the URI format, such as sip:myFriends@chat.sonera.com. However, a software client, such as software running in a terminal, is not able to make a difference between a URI of a single user and a URI defining a group of users.

Also in the PoC, a subscriber is identified by a URI and may thus be an individual user or a group of individual users. As explained above, in the PoC, a subscriber may join a group for a group session. The URI identifying the joining subscriber may be operated by another operator than the operator operating the controlling server. If in such a situation the URI defines a group of users, two controlling servers would be managing the session, for example mixing the speech. Inviting a group to join a PoC session may also cause problems relating to charging, in particular if the inviting (calling) party is not aware that the invited (called) party is a group. Typically, the calling party pays for the call and may thus have to pay for a surprisingly large number of call legs.

To overcome a part of these problems, it has been proposed to introduce a new header parameter in Contact headers in requests and responses in the SIP, namely an “isfocus” tag. The “isfocus” tag expresses that a SIP dialog belongs to a conference, i.e. that a user agent is a conference server, also known as a focus, and will mix together the media for all calls to the same URI. When the “isfocus” tag is set together with the URI e.g. in the Contact header, the URI in question points to the conference focus. The focus serves as a central node of the signalling for a conference. The focus, for example, controls the mixer, which does the mixing of the media, such as voice streams. In addition, the focus has a set of rules for each conference, i.e. the conference policy defining the properties of the conference, such as access control list, dial-out list, possibly conference start time and stop time, and so on.

However, there is a need for alternative manners to provide information on a resource in a communication system, such as whether the resource comprises an individual user identity or a plurality of user identities.

It shall be appreciated that these issues are not limited to any particular communication environment, but may occur in any appropriate communication system.

### SUMMARY OF THE INVENTION

Embodiments of the invention aim to address one or several of the above problems or issues.

In accordance with an aspect of the invention, there is provided a method for providing information on a resource in a communication system. The method comprises receiving a request from a first entity in a second entity, the request being addressed to a second resource and providing to the request a response comprising a group indication when the second resource defines a group comprising a number of individual resources.

In accordance with another aspect of the invention, there is provided a computer program comprising program code means for performing any of the steps of the method according to the invention when the program is run on a computing means.

In accordance with another aspect of the invention, there is provided an identifier of a resource in a communication system, comprising a group indication when the resource defines a group comprising a number of individual resources.

In accordance with another aspect of the invention, there is provided an entity in a communication system. The entity comprises receiver for receiving a request from a first entity, the request being addressed to a resource and response means for providing to the request a response comprising a group indication when the resource defines a group comprising a number of individual resources.

In an embodiment, an entity is configured to receive a request from a first entity, the request being addressed to a resource and provide to the request a response comprising a group indication when the resource defines a group comprising a number of individual resources.

In accordance with another aspect of the invention, there is provided a user terminal configured to recognize a group indication in an identifier of a resource and to adjust a user interface of the terminal based on the group indication.

In accordance with another aspect of the invention, there is provided a entity in a communication network. The entity comprises sending means for sending a request to a resource, receiving means for receiving a response to the request and detecting means for detecting a group indication in the response.

In an embodiment, an entity in a communication network is configured to send a request to a resource, receive a response to the request and detect a group indication in the response.

In an embodiment, the step of receiving the request may comprise receiving an invitation for a communication session. The invitation for a communication session may be an INVITE request of the Session Initiation Protocol. In an embodiment, the step of receiving the request may comprise receiving an OPTIONS request of the Session Initiation Protocol.

The method may further comprise verifying whether the second resource defines a group comprising a number of individual resources. Verifying may comprise resolving the second resource by consulting a third entity.

In an embodiment, the group indication may be provided together with an identifier of the second resource.

In an embodiment, the step of providing the response may comprise providing a Contact header of a Uniform Resource Identifier with a group indication parameter.

The group indication may comprise a tag, bit or ASCII string indicating that the second resource defines a group comprising a number of individual resources. In an embodiment, the group indication may comprise an “isResourceList” tag. In an embodiment, the group indication may comprise information for interrogating a resource list comprising information on the individual resources of the group.

In an embodiment, the second entity may be a conference server. The request may include an indication that there is another conference server on a path of the request. Said indication may be “isFocus” parameter of Session Initiation Protocol. In an embodiment, the step of providing the response to the request may comprise rejecting the request if the second resource defines a group. The step of rejecting may comprise providing information for interrogating a resource list comprising information on the individual resources of the group. The method may further comprise requesting at least one of the individual resources for a communication based on said information for interrogating the resource list.

### BRIEF DESCRIPTION OF THE DRAWINGS

The invention will now be described in further detail, by way of example only, with reference to the following examples and accompanying drawings, in which:

FIG. 1 shows an example of an arrangement in which the embodiments of the invention may be implemented;

FIG. 2 shows a flow chart illustrating an embodiment of the invention; and

FIG. 3 shows an embodiment of the invention.

### DETAILED DESCRIPTION OF PREFERRED EMBODIMENTS

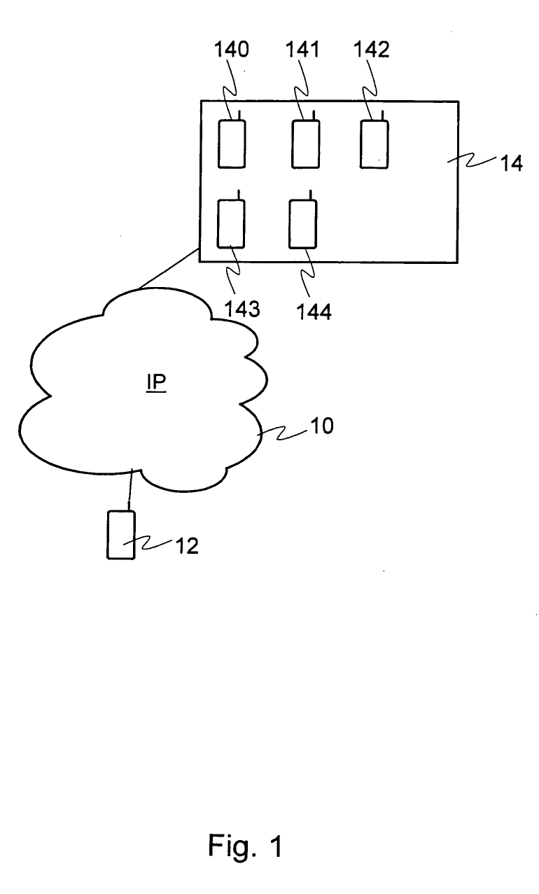

FIG. 1 shows an example of an arrangement including a communication network 10, a user terminal 12 and a group 14 of a plurality of user terminals 140, 141, 142, 143 and 144. The communication network 10 may be any appropriate communication network. In an embodiment, the communication network 10 is provided at least in part by the IMS.

It shall be appreciated that FIG. 1 is only an example showing one individual user terminal and one group of five user terminals. The number and type of these entities may differ substantially from that which is shown.

In this specification, terms user, end-user, user agent, subscriber and resource all refer to an entity able to using services via a communication network. A user or user agent is typically an individual registered user identity. Term end-user may be used to denote a human user of the system. A subscriber or resource may refer to an individual user or to a group of users subscribing a single subscription. Terms resource list and group define herein an entity having an own identifier, such as an own URI, and comprising a number of entities each having a different identifier, such as a different URI.

A SIP user agent may have received in some manner a URI from the network. The URI may be, for example, received in a message, found on a web site or given manually by an end-user. However, the user agent may not know whether the URI defines an individual user or a group of users.

In the present invention, a new mechanism has been developed for resolving or indicating whether a URI defines a resource list, i.e. a group of individual users, instead of an individual user. In the present invention, the URI is provided with a new portion indicating that the URI in question does not point to only one resource but to a plurality of individual resources, such as individual URIs. The new portion may be a tag, bit or ASCII string and be referred to as a group indication or a resource list indication.

According to the invention, a method for providing information on a resource in a communication system is provided. The method comprises receiving a request from a first entity in a second entity, the request being addressed to a second resource. The method further comprises providing to the request a response comprising a group indication when the second resource defines a group comprising a number of individual resources. Various optional steps may be included in the method, some examples of which are described in the following description illustrating the group indication and its function according to embodiments of the invention.

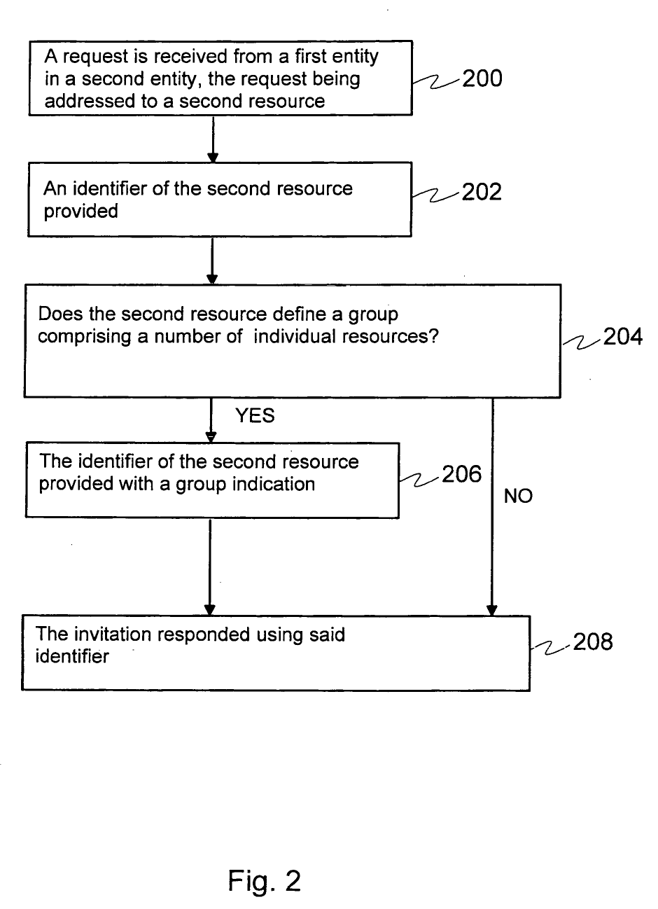

FIG. 2 shows a flowchart illustrating an embodiment of the invention. In step 200, a request, such as an invitation for a communication session, is received from a first entity in a second entity, the request being addressed to a second resource. The invitation may be received by an entity responsible for routing requests towards the second resource, or responsible for maintaining a plurality of URIs, the second resource being one of the URIs. In step 202, an identifier of the second resource is provided. In step 204, it is verified whether the second resource defines a group comprising a number of individual resources. In step 206, the identifier of the second resource is provided with a group indication when the second resource defines a group comprising a number of individual resources. In step 208, the invitation is responded using said identifier. If the second resource comprises only an individual resource, the identifier may have an appropriate format, such as a known URI format.

For the SIP, an additional operation called OPTIONS method is defined in the RFC 3261, Section 11, for querying for capabilities of a SIP server or client. The RFC 3261 defines an OPTIONS request and an OPTIONS response such that a response to a request is constructed using the standard rules for a SIP response. The response code chosen is the same that would have been chosen had the request been an INVITE. In the RFC 3261, the response includes a Contact header defining a direct route to contact the sender. The Contact header is given in the known URI format as defined above, such as Contact: <sip:carol@(chicago.com>.

According to an embodiment of the invention a new tag, for example, “isResourceList” tag, may be introduced in the URI. According to this embodiment, the “isResourceList” tag is used to indicate that a resource identified by the URI is a resource list, i.e. group of individual contacts. The “isResourcelist” tag may be added in the end of a URI in appropriate SIP message header(s), such as the Contact header, to give more information on the resource to which the URI points. According to a further embodiment, a user may be allowed to interrogate the actual members behind a list, in addition to an indication that the URI is a list.

The resource list is a set of URIs each defining an individual contact. The resource list is identified with an own SIP URI and possibly also with e.g. HTTP or XCAP (Extensible Markup Language (XML) Configuration Access Protocol) URI for managing the list. The resource list does not have similar properties than the above defined focus does, for example the resource list it does not control a mixer and so on. In an embodiment, the resource list may be part of conference policy, for instance the access control list of a conference can be a resource list.

An example of an OPTIONS request may be formed as follows. Not all headers are shown, only those relevant for the embodiment:
OPTIONS sip:myBuddies@chat.sonera.com SIP/2.0
To: sip:myBuddies@chat.sonera.com
From: A@sonera.com
Contact: <sip:A@pc.sonera.com>

An example of an OPTIONS response to the request of the above example, using the “isResourceList” tag according to an embodiment of the invention:
SIP/2.0 200 OK
To: sip:myBuddies@chat.sonera.com
From: sip:@sonera.com
Contact: <sip:myBuddies@chat.sonera.com>; isResourceList

In an embodiment, a header “Associated-List-Manipulation” may carry an Extensible Markup Language (XML) Configuration Access Protocol (XCAP) resource list URI. The XCAP is a protocol that allows clients to manipulate XML documents stored in a server and serving as configuration information for application protocols. An XCAP resource list subscriptions allow a client to have a single SIP subscription to a list of users and the list is maintained on a server.

In an embodiment, an Associated-List-Manipulation header may be used in 200 OK response of the OPTIONS method. The Associated-List-Manipulation header may carry information defining that the URI the enquiry related to was a resource list. Furthermore, the Associated-List-Manipulation header may carry an address, which may be used to interrogate and manipulate the resource list. Once a user agent has received an XCAP resource list URI, the user agent can, for example, query the members in the lists.

An example of an OPTIONS request may be formed as follows. Not all headers are shown, only those relevant for the embodiment:
OPTIONS sip:myBuddies@chat.sonera.com SIP/2.0
To: sip:myBuddies@chat.sonera.com
From: A@sonera.com
Contact: <sip:A@pc.sonera.com>

An example of an OPTIONS response to the request of the above example, using the Associated-List-Manipulation header according to an embodiment of the invention:
SIP/2.0 200 OK
To: sip:myBuddies@chat.sonera.com
From: sip:@sonera.com
Contact: <sip:myBuddies@chat.sonera.com>
Associated-List-Manipulation:
http://xcap.example.com/services/chat-lists/users/joe/mydir/mybuddies.xml

In an embodiment, the above-described mechanism can be used with conference SIP URIs. The 200 OK response for OPTIONS may return an “isfocus” tag in the Contact header. In addition, the 200 OK response may return an Associated-List-Manipulation header according to an embodiment of the invention.

The embodiments described above may be used together. The 200 OK response of the OPTIONS method may contain both and “isResourceList” tag and an Associated-List-Manipulation header.

The group indication according to embodiments of the invention, such as the “isResourceList” tag, allows indicating that the URI in question does not point to only one resource or contact but to a plurality of individual resources or contacts in a manner compatible with the present standards. Thus, a terminal or software may be configured to recognize the new group indication. Embodiments of the invention may allow the terminal or software to inform the user of the terminal or the software that the URI is a group or resource list URI. In an embodiment, the user may be displayed a specialized menu, for example comprising “retrieve group members” option or the like.

In an embodiment, when the user agent has received a response to an OPTIONS request and the response reveals that the URI points to a resource list, the user agent may provide the end-user with possibility to view and/or manipulate the list. For instance, if the response contains an XCAP URI e.g. in the Associated-List-Manipulation header, the user agent may send an XCAP query and receives the content of the list.

In an embodiment, a user may find an URI from a source, such as from the Internet. By clicking the URI, an OPTION request may be initiated and the user may receive a response comprising a group indication, such as “isResourceList”. The terminal may be configured to provide a user, in the user interface, a menu or the like, which is different when the URI defines a group of users than when the URI defines an individual user.

In the Push to talk over Cellular (PoC) service, a subscriber may join a group, for example during an ongoing session or for establishing a session between subscribers. The PoC session is managed by a first server. In an embodiment, the joining subscriber may be invited by the group having the ongoing session or party wishing to establish a session. The joining subscriber may thus be called an invited subcriber. The invited subscriber, itself, may be a group and managed by an own server, a second server. If the invited subscriber is a group, the second server may respond by rejecting the invitation. The second server may inform the first server that the invited subscriber is a group. This may be done using the group indication according to embodiments of the invention. Optionally, the group indication may comprise information on the members of the group or how the members of the invited group can be recognised individually, thereby allowing inviting the members to join the session one by one. In an embodiment, the second server may respond by accepting the inviting request but inform by a group indication the first server that the invited subscriber is a group.

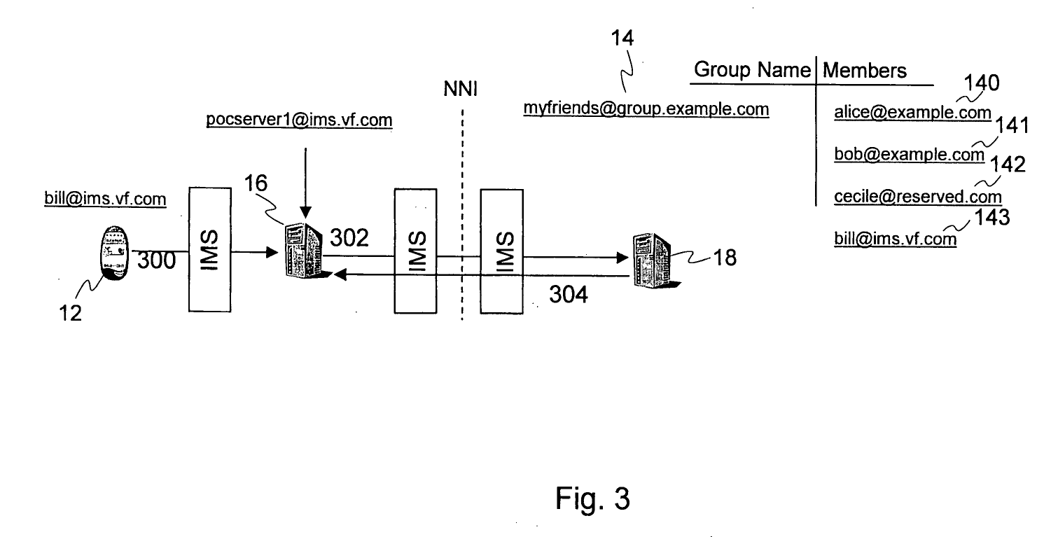

FIG. 3 shows an example where a user 12 wants to create a PoC group session in the home network of the user 12. In step 300, the user 12 uses a predefined conference URI to address by an INVITE request a first PoC server 16 in the network. The request contains myfriends@example.com as the called party address 14. The user may request also other participants, but here, for simplicity, only procedure for inviting myfriends@example.com is shown. The first PoC server 16 recognises that the called party (i.e. target identity) is hosted in a different network and sends the request towards the target network over the network-to-network interface (NNI) using the IMS infrastructure. As the first PoC server 16 is not aware of the nature of the target identity, it assumes that the called party is an individual user and continues processing in step 302. The first PoC server 16 may set an “isfocus” parameter to indicate that it acts as a conference server and it will mix the media for conference participants. The IMS of the target network routes the request to a second PoC server 18 controlling the myfriends@example.com called party address 14. When the request arrives at the second PoC server 18, it recognises or determines that the target identity is not an individual user identity. In an embodiment, the second PoC server 18 may resolve this information by consulting a third entity, such as a group and list management server (GLMS). As the request contained the “isfocus” parameter, the second PoC server 18 rejects the request in step 304 by sending a reject message comprising a group indication according to the invention to the first PoC server 16. The reject message may contain information on the members 140, 141, 142, 143 of the group 14. The first PoC server 16 may pass the reject message and the information on the members to the calling subscriber 12.

In the above embodiment, the URI identifying the joining subscriber, i.e. the called party address 14, is operated by another operator than the operator operating the first PoC server 16. The URI of the called party 14 defines a group of users. The second PoC server 18 thus rejects the request to avoid a situation where two controlling servers would be managing the session, for example mixing the speech. Examples of reasons why the second PoC server 18 may want to reject the request may comprise, but are not limited to, technical problems and policy decisions. It may not be possible to manage a situation of more than one conference or PoC servers involved in a session for technical reasons. Operators may want to keep network or conference topology simple even it was technically possible to have several conference servers involved in a conference or PoC session.

In an embodiment, when the reject message contains information on the members of the group, the first PoC server 16 may use the provided contact information to invite members of the group one by one.

In an embodiment, the called party address 14 may define an open group, such as an open chat room, which may contain hundreds of users. In such a case, rejecting the request may be advisable.

Some of the embodiments of the invention may at least partially be realized in appropriate network elements by means of a computer program. The computer program may comprise program code means for performing steps according to said embodiments when the program is run on a computing means.

Although the invention has been described in the context of particular embodiments, various modifications are possible without departing from the scope and spirit of the invention as defined by the appended claims. It should be appreciated that whilst embodiments of the present invention have mainly been described in relation to mobile user equipment such as mobile terminals, embodiments of the present invention may be applicable to other types of user equipment that may access communication networks. Furthermore, the communication system may be any appropriate communication system, even if reference has mainly been made to mobile communication systems.

1. A method for providing information on a resource in a communication system, the method comprising:
receiving a request from a first entity in a second entity, the request addressed to a resource; and
providing a response to the request comprising a group indication when the resource defines a group comprising a number of individual resources.

2. A method according to claim 1, wherein the step of receiving the request comprises receiving an invitation for a communication session.

3. A method according to claim 2, wherein the step of receiving the invitation comprises receiving an INVITE request of a session initiation protocol.

4. A method according to claim 1, wherein the step of receiving the request comprises receiving an OPTIONS request of a session initiation protocol.

5. A method according to claim 1, further comprising verifying whether the resource defines the group comprising the number of individual resources.

6. A method according to claim 5, wherein the step of verifying comprises resolving the resource by consulting a third entity.

7. A method according to claim 1, wherein the step of providing the response comprises providing the group indication together with an identifier of the resource.

8. A method according to claim 1, wherein the step of providing the response comprises providing a contact header of a uniform resource identifier with a group indication parameter.

9. A method according to claim 1, wherein the group indication comprises a tag, bit or ASCII string indicating that the resource defines the group comprising the number of individual resources.

10. A method according to claim 9, wherein the group indication comprises an “isResourceList” tag.

11. A method according to claim 1, wherein the group indication comprises information for interrogating a resource list comprising information on the individual resources of the group.

12. A method according to claim 1, wherein the second entity comprises a conference server.

13. A method according to claim 12, wherein the request includes an indication that there is another conference server on a path of the request.

14. A method according to claim 13, wherein said indication comprises an “isFocus” parameter of session initiation protocol.

15. A method according to claim 13, wherein the step of providing the response to the request comprises rejecting the request if the resource defines the group.

16. A method according to claim 15, wherein the step of rejecting comprises providing information for interrogating a resource list comprising information on the individual resources of the group.

17. A method according to claim 16, further comprising requesting at least one of the individual resources for a communication based on said information for interrogating the resource list.

18. A computer program embodied on a computer-readable medium, said computer program configured to control a computer to perform the steps of:
receiving a request from a first entity in a second entity, the request addressed to a resource, and
providing a response to the request comprising a group indication when the resource defines a group comprising a number of individual resources.

19. An identifier of a resource in a communication system, the identifier comprising a group indication when the resource defines a group comprising a number of individual resources.

20. An identifier according to claim 19, wherein the group indication is included in a contact header of a uniform resource identifier.

21. An identifier according to claim 19, wherein the group indication comprises a tag, bit or ASCII string indicating that the resource defines the group comprising the number of individual resources.

22. An identifier according to claim 21, wherein the group indication comprises an “isResourceList” tag.

23. An identifier according to claim 19, wherein the group indication comprises information for interrogating a resource list comprising information on the individual resources of the group.

24. An entity in a communication system, the entity comprising:
a receiver for receiving a request from a first entity, the request addressed to a resource; and
response means for providing a response to the request comprising a group indication when the resource defines a group comprising a number of individual resources.

25. An entity according to claim 24, further comprising resolving means for resolving whether the resource defines the group comprising the number of individual resources.

26. An entity according to claim 25, wherein the resolving means for resolving are configured to communicate with a further entity while resolving the resource.

27. An entity according to claim 25, further comprising examining means for examining whether the request includes an indication that a conference server is on a path of the request.

28. An entity according to claim 27, wherein the response means are configured to reject the request if the indication that the conference server is on the path is present and the resource defines the group comprising the number of individual resources.

29. An entity according to claim 28, wherein the response means are further configured to include information for interrogating a resource list comprising information on the individual resources of the group in the rejection.

30. An entity according to claim 24, wherein the entity comprises at least one of a conference server and a Push to talk over Cellular (PoC) server.

31. An entity in a communication system configured to:
receive a request from a first entity, the request addressed to a resource; and
provide a response to the request comprising a group indication when the resource defines a group comprising a number of individual resources.

32. A user terminal configured to recognize a group indication in an identifier of a resource and to adjust a user interface of the user terminal based on the group indication.

33. A user terminal according to claim 32, comprising requesting means for requesting whether the resource comprises a list of individual resources.

34. A user terminal according to claim 33, wherein the requesting means are configured to send a request comprising said resource to a network.

35. A user terminal according to claim 33, configured to receive a response to said request.

36. A user terminal according to claim 33, comprising means for providing a menu for a user in a user interface based on detecting that the resource is a list of individual resources.

37. A user terminal according to claim 32, configured to display a menu comprising an option allowing a user of the user terminal to interrogate information on individual resources relating to the group indication.

38. An entity in a communication network, the entity comprising:
sending means for sending a request to a resource;
receiving means for receiving a response to the request; and
detecting means for detecting a group indication in the response.

39. An entity in a communication network configured to:
send a request to a resource;
receive a response to the request; and
detect a group indication in the response.

40. An entity according to claim 39, configured to detect information for interrogating a resource list comprising information on individual resources of the group in the response.

41. An entity according to claim 40, configured to resolve the individual resources of the group.

42. An entity according to claim 39, further configured to detect individual resources of group members in the response.

43. An entity according to claim 41, configured to send the request to at least one of the individual resources.
